(19) United States
(12) Patent Application Publication
(10) Pub. No.: US 2025/0211621 A1
(43) Pub. Date: Jun. 26, 2025

(54) CLOUD SERVICE SECURITY RISK ASSESSMENT AND MANAGEMENT

(71) Applicant: Microsoft Technology Licensing, LLC, Redmond, WA (US)

(72) Inventors: Lawrence John HEJL, JR., Arlington, VA (US); Dustin Brent SHIRLEY, Pasadena, MD (US); Anthony Blaine MATHENA, Chapel Hill, NC (US); Gary PAGAN, Severna Park, MD (US); John Kenneth ALLEN, Kirkland, WA (US); Roger Hari LONGDEN, Redmond, WA (US); Patrick William ARNOLD, Gambrills, MD (US); Terry Field RAGAN, Bristol, TN (US)

(73) Assignee: Microsoft Technology Licensing, LLC, Redmond, WA (US)

(21) Appl. No.: 18/393,109

(22) Filed: Dec. 21, 2023

(51) Int. Cl. H04L 9/40

(52) U.S. Cl. CPC H04L 63/20

(57) ABSTRACT

A computer-implemented approach for assessing and managing risk of a cloud service is disclosed. Cloud computing resource data for a cloud service is received. A risk assessment framework is applied to the cloud computing resource data. The risk assessment framework includes a set of security criteria including a subset of data plane criteria and a subset of control plane criteria. The risk assessment framework assigns an individual risk score to each security criteria of the set. The individual risk scores of the set of security criteria are aggregated to generate an overall risk score for the cloud service. A graphical user interface including the overall risk score is visually presented via a display. A computer-automated risk management operation that automatically adjusts security settings of the cloud service based at least on the cloud computing resource data for the cloud service is executed to enhance security of the cloud service.

### BACKGROUND

Cloud service providers offer a variety of cloud computing services and resources delivered over the internet. Cloud computing services allow individuals and organizations to access and use computing resources, such as storage, processing power, databases, networking, and software applications, without the need to own or maintain physical infrastructure. Instead of investing in and managing their own servers and data centers, customers can leverage the resources offered by cloud service providers on a pay-as-you-go basis.

### SUMMARY

A computer-implemented approach for assessing and managing risk of a cloud service is disclosed. Cloud computing resource data for a cloud service is received. A risk assessment framework is applied to the cloud computing resource data. The risk assessment framework includes a set of security criteria including a subset of data plane criteria and a subset of control plane criteria. The risk assessment framework assigns an individual risk score to each security criteria of the set. The individual risk scores of the set of security criteria are aggregated to generate an overall risk score for the cloud service. A graphical user interface including the overall risk score is visually presented via a display. A computer-automated risk management operation that automatically adjusts security settings of the cloud service based at least on the cloud computing resource data for the cloud service is executed to enhance security of the cloud service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing environment in which a computing system is implemented to assess and manage risk of using a cloud service.

FIG. 2 shows aspects of an example risk assessment framework including a plurality of different risk levels of an example security criteria that is applied to an example cloud service.

FIG. 3 shows an example user interface including a plurality of risk scores for a cloud service.

FIG. 4 shows an example user interface including security settings of a cloud service that are automatically adjusted by computer-automated risk management operations to enhance security of the cloud service.

FIG. 5 shows an example user interface including notification related to compliance monitoring of a cloud service.

FIGS. 6-7 shows a flow chart of an example computer-implemented method for assessing and managing risk of a cloud service provider.

FIG. 8 schematically shows an example computing system.

### DETAILED DESCRIPTION

Cloud computing customers with sensitive workloads desire unique protections to ensure availability, confidentiality, and integrity of their data and operations. Beyond conventional cryptographic isolation and standards compliance offered by cloud service providers (CSPs), customers with sensitive workloads desire to use a cloud service that meets security standards and enforces configuration best practices for network, data, and compute isolation, and ensure customer data is protected against unauthorized access, modification, or disclosure.

However, it is difficult for an individual or organization to assess the ability of a cloud service to meet such security standards. This ability is described herein in the context of risk. More particularly, risk assessment for a cloud service requires a high level of knowledge, expertise, and skill to be able to comprehend and accurately assess the ability of a cloud service to meet such security standards. In many cases, individuals and organizations do not have the resources to be able to make such risk assessments.

Accordingly, the present disclosure is directed to a computer-implemented approach for assessing and managing the risk of using a cloud service in a highly secure workload. A highly secure workload is a set of customer data and operations that require a high level of security to prevent unauthorized access, modification, or disclosure. In one example implementation, cloud computing resource data for a cloud service is received. A risk assessment framework is applied to the cloud computing resource data for the cloud service. The risk assessment framework includes a set of security criteria including a subset of data plane criteria and a subset of control plane criteria. The risk assessment framework assigns an individual risk score to each security criteria of the set of security criteria based at least on evaluating the cloud computing resource data to determine a degree to which the cloud service complies with the corresponding security criteria. The individual risk scores of the set of security criteria for the cloud service are aggregated to generate an overall risk score for the cloud service that indicates a level of risk that a customer would face by using the cloud service. A graphical user interface including the overall risk score of the cloud service is visually presented via a display. A computer-automated risk management operation that automatically adjusts security settings of the cloud service based at least on cloud computing resource data of the cloud service is executed to enhance security of the cloud service.

The computer-implemented approach provides a comprehensive and objective evaluation of the security posture of a cloud service. More particularly, the risk assessment framework employed by the computer-implemented approach provides the technical benefit of translating qualitative technical security factors into simple, quantitative risk scores that enable the customer to make informed decisions about the selection and use of a cloud service in a highly secure workload. The risk assessment framework is based on the latest security standards and can be updated as the security standards change over time. Moreover, in some implementations, the risk assessment framework can be customized to the specific needs and preferences of the customer.

The computer-implemented approach helps customers identify, mitigate, and manage risks to sensitive data and operations in both the customer-facing data plane and the cloud service-facing control plane. While most conventional approaches focus on customer workloads in the data plane, the computer-implemented approach manages risk in both data and control planes to provide the technical benefit of ensuring that customer workloads and data are protected not only from traditional threat vectors, such as other cloud tenants and external cyberthreats, but also from unauthorized access by CSP staff performing customer support activities.

The computer-implemented approach provides automated compliance monitoring and enforcement, which provides a continuous and proactive assurance of the security of the cloud service. The automated compliance monitoring and enforcement leverages computer-automation to collect and analyze security data from the cloud service and execute predefined responses when the cloud service deviates from the security standards. The automated compliance monitoring and enforcement reduces the human error and intervention that may compromise the security of the service.

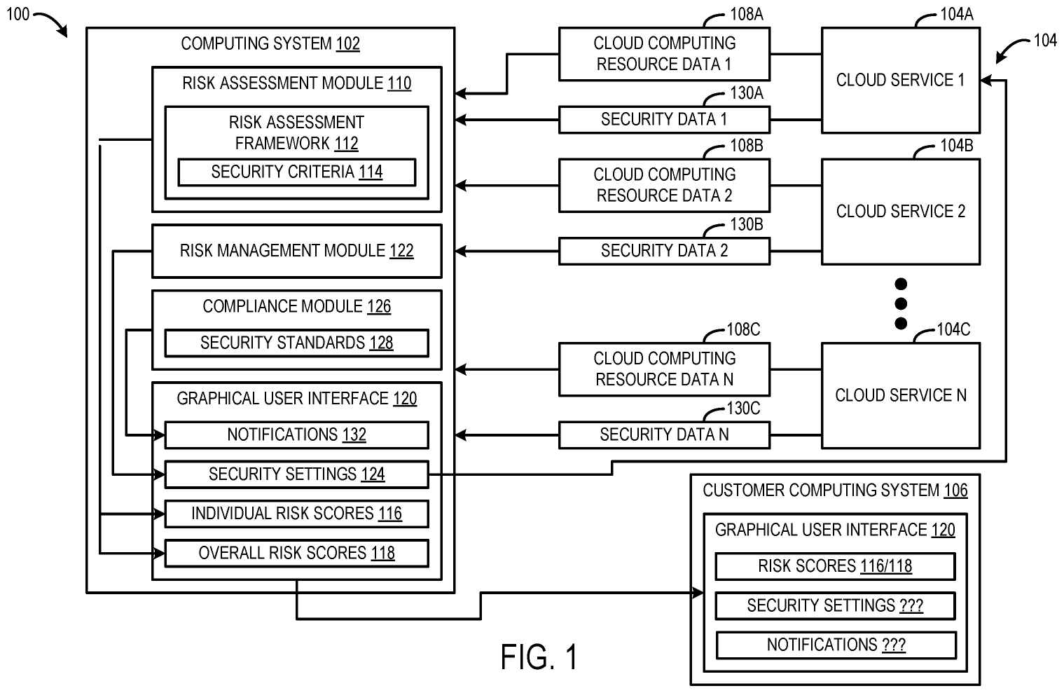

FIG. 1 schematically shows an example computing environment 100 in which a computing system 102 is implemented to assess and manage risk of using a cloud service. The computing system 102 is configured to communicate with a plurality of different cloud services 104 (e.g., a first cloud service 104A, a second cloud service 104B, a N^{th} cloud service 104C) via a computer network, such as the Internet. The computing system 102 may be configured to assess and manage risk of any suitable number of different cloud services depending on the implementation.

The computing system 102 is configured to communicate with a customer computing system 106 via a computer network, such as the Internet. The computing system 102 is configured to provide a holistic approach to risk management for the customer computing system 106 throughout an entire life cycle of secure cloud workloads of the customer computing system 106. Risk is continually quantified, further reduced, and automatically monitored and enforced by the computing system 102 to ensure customer data and operations are protected by optimal security, even as customer architectures and cloud technology rapidly evolve. To that end, the computing system 102 is configured to assess risk scores for the plurality of cloud services 104, which provide comprehensive and objective evaluations of the security postures of each of the plurality cloud services 104. In this way, the customer computing system 106 can be accurately informed of a level of risk that the customer computing system 106 would face by using the different cloud services.

Note that the computing system 102 may be configured to assess and manage risk for any suitable number of different customer computing systems depending on the implementation.

The computing system 102 is configured to receive cloud computing resource data 108 for each of the plurality of cloud services 104. In the illustrated example, the computing system 102 receives the first cloud computing resource data 108A from the first cloud service 104A, the second cloud computing resource data 108B from the second cloud service 104B, and the Nth cloud computing resource data 108C from the Nth cloud service 104C. The computing system 102 may receive the cloud computing resource data from the plurality of cloud services 104 in any suitable manner. In some examples, the computing system 102 may actively monitor the plurality of cloud services 104 and continuously receive the cloud computing resource data from the plurality of cloud services 104. In other examples, the plurality of cloud services 104 may repeatedly push the cloud computing resource data to the computing system, such as whenever the cloud computing resources of a cloud service change. In yet other examples, the cloud computing resource data may be collected from a cloud service by a third-party aggregator and forwarded to the computing system 102.

The cloud computing resource data 108A, 108B, 108C characterizes various components and capabilities that the different cloud services offer to customers. Example types of resources that can be characterized by the cloud computing resource data 108A, 108B, 108C include, but are not limited to, computer resources (e.g., virtual machines, containers, serverless functions), storage resources (e.g., object storage, block storage, file storage), networking resources (e.g., virtual networks, load balancers, content delivery networks), database resources (e.g., relational databases, NoSQL databases, in-memory databases), security and identity resources (e.g., identity and access management, encryption services, firewalls and security groups), monitoring and management resources (e.g., logging and monitoring services, automation tools, resource management console), and developer and application resources (e.g., development platforms, application hosting services).

The computing system 102 includes a risk assessment module 110 configured to analyze the cloud computing resource data 108A, 108B, 108C of the plurality of cloud services 104A, 104B, 104C to assess the level of risk that a customer computing system, such as the customer computing system 106 faces by using the cloud service in a highly secure workload and informs the customer computing system of the potential impact and likelihood of a security breach or compromise of the cloud service. For example, to assess the level of risk of using the first cloud service 104A, the risk assessment module 110 is configured to apply a risk assessment framework 112 to the cloud computing resource data 108A for the cloud service 104A.

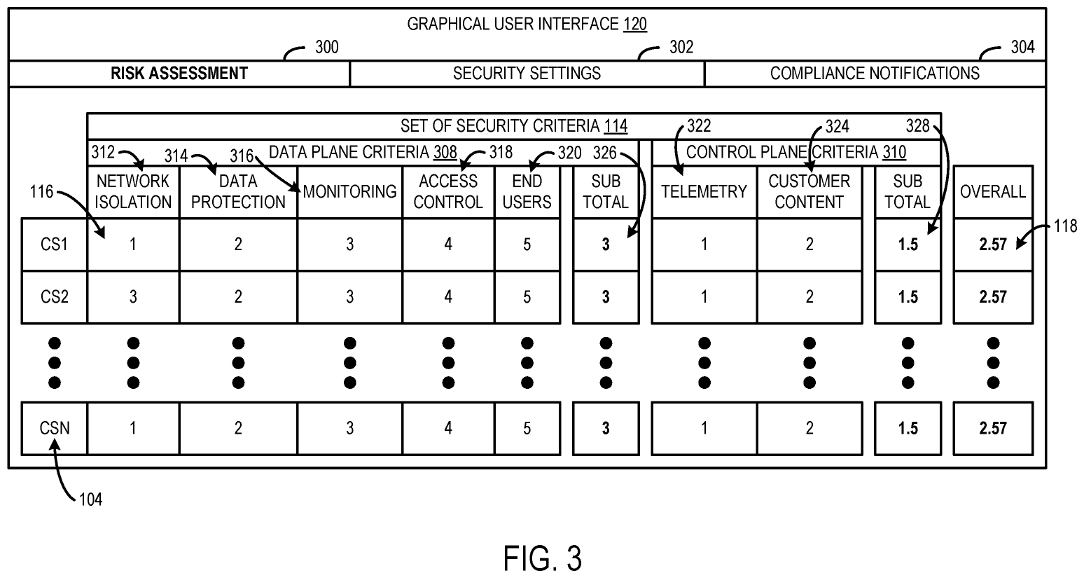

The risk assessment framework 112 is a methodology to evaluate the security posture of a cloud service based at least on a set of security criteria 114. The set of security criteria 114 considers risks both in the customer-facing data plane and CSP privileged access in the cloud control plane. In particular, the set of security criteria 114 includes a subset of data plane criteria 308 (shown in FIG. 3) and a subset of control plane criteria 310 (shown in FIG. 3). In cloud computing, the control plane refers to the set of components responsible for managing and controlling the cloud infrastructure and services. It is distinct from the data plane, which is responsible for the actual processing and movement of user data within the infrastructure. The control plane is responsible for the orchestration, configuration, and coordination of various resources and services in the cloud environment.

In the illustrated implementation, the subset of data plane criteria 308 includes network isolation criteria 312, data protection criteria 314, monitoring criteria 316, access control criteria 318, and end users criteria 320.

The network isolation criteria 312 assesses a degree to which a cloud service implements effective network isolation to reduce the likelihood of unauthorized access and the potential impact of security incidents. Example network isolation features that a cloud service may implement in the data plane include virtual private clouds, subnet segmentations, firewalls and network security groups, network access control lists, virtual private networks and direct connections, private link services, and other types of network isolation features.

The data protection criteria 314 assesses a degree to which a cloud service implements features to protect confidentiality, integrity, and availability of sensitive data. Example data protection features that a cloud service may implement in the data plane include data encryption (e.g., while data is in transit and/or in storage), data classification, data residency and jurisdiction, data masking and anonymization, logging and auditing, incident response and forensic readiness, secure development practices, and other types of data protection features.

The monitoring criteria 316 assesses a degree to which a cloud service implements features to detect and respond to security incidents, performance issues, and other events that may impact the security and availability of secure workloads. Example monitoring features that a cloud service may implement in the data plane include real-time logging services, altering and notification features, security information and event management solutions, network traffic monitoring, resource utilization monitoring, configuration changes tracking, incident response automation, vulnerability scanning, compliance monitoring, user behavior analytics, cloud service provider security alerts, and other types of monitoring features.

The access control criteria 318 assesses a degree to which a cloud service implements features to manage and govern access to resources, data, and services in a cloud computing environment. Example access control features that a cloud service may implement in the data plane include identity and access management, multi-factor authentication, strong authentication protocols, federation and single sign-on, access reviews, resource tagging, network access controls, data access controls, API security, access logging, least privilege principles, geo-location restrictions, session management, temporary access, incident response access, compliance checks and other types of access control features.

The end users criteria 320 assesses a degree to which a cloud service implements features to manage end user security. Example end user features that a cloud service may implement in the data plane include strong password policies, multi-factor authentication, user provisioning and deprovisioning, role-based access control, security awareness training, endpoint protection, secure access channels, collaboration security, email security, endpoint patching and updates, mobile device management, secure file sharing, cloud service education, user agreements, emergency access policies, and other types of end user features.

In the illustrated implementation, the subset of control plane criteria 310 (shown in FIG. 3) includes telemetry criteria 322 (shown in FIG. 3) and customer content criteria 324 (shown in FIG. 3).

The telemetry criteria 322 assesses a degree to which a cloud service implements features to monitor and manage security related to CSP privileged access to secure workloads of a customer. Example telemetry features that a cloud service may implement in the control plane include API activity monitoring, user and role activity monitoring, configuration change tracking, audit trails of control plane events, resource provisioning tracking, service limit monitoring, access request monitoring, error and exception tracking, network traffic analysis, control plane performance metrics, security policy violation detection, resource dependency mapping, baseline anomaly detection, telemetry data storage and retention for incident response readiness and forensics, integration of telemetry data with security information and event management, encryption and integrity of telemetry data, and other types of telemetry features.

The customer content criteria 324 assesses a degree to which a cloud service implements features to manage the infrastructure, access controls, and configurations that govern the handling and protection of customer data. Example customer content features that a cloud service may implement in the control plane include audit logging, log retention, access control monitoring, encryption status monitoring, key management, behavior analytics, compliance checks, data loss prevention, and other types of customer content features.

The set of security criteria 114 may include any suitable category of criteria that can be used to assess a security risk level of a cloud service. In some implementations, the number of criteria may be significantly larger than what is shown in the illustrated example. For example, the set of security criteria 114 may include hundreds of different types or categories of security criteria.

The risk assessment framework 112 assigns an individual risk score 116 to each type of security criteria of the set of security criteria 114 based at least on evaluating the cloud computing resource data 108A to determine a degree to which the cloud service 104A complies with the corresponding security criteria. The individual risk scores 116 can have a designated range of risk levels. For example, the individual risk scores 116 can range from 1 to 5, with 1 being the lowest level of risk and 5 being the highest level of risk. The designated range of risk levels can be any suitable size to communicate any suitable granularity level of different degrees of risk.

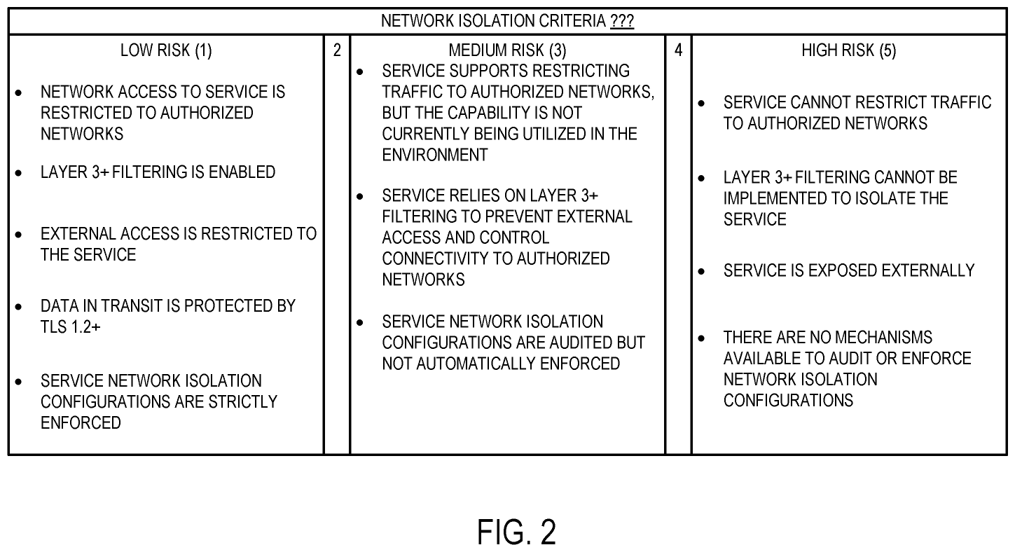

FIG. 2 shows an example range of individual risk levels for network isolation criteria 312 that is included in the set of security criteria 114. The network isolation criteria assesses a degree to which a cloud service implements effective network isolation to reduce the likelihood of unauthorized access and the potential impact of security incidents. In the illustrated example, a cloud service is assessed to have a low individual risk level (e.g., level 1) based on the network isolation criteria 312, if network access to the cloud service is restricted to authorized networks, layer 3+ filtering is enabled, external access is restricted to the cloud service, data in transit is protected by TLS 1.2+, and service network isolation configurations are strictly enforced.

A cloud service is assessed to have a medium individual risk level (e.g., level 3) based on the network isolation criteria 312, if the cloud service supports restricting traffic to authorized networks, but the capability is not currently being utilized in the computing environment, the cloud service relies on layer 3+ filtering to prevent external access and control activity to authorized networks, and cloud service network isolation configurations are audited but not automatically enforced. A cloud service is assessed to have an individual risk level of 2 based on the network isolation criteria 312, if the cloud service has network isolation features between levels 1 and 3.

A cloud service is assessed to have a high individual risk level (e.g., level 5) based on the network isolation criteria 312, if the cloud service cannot restrict traffic to authorized networks, layer 3+ filtering cannot be implemented to isolate the cloud surface, the cloud service is exposed externally, and there are no mechanisms available to audit or enforce network isolation configurations. A cloud service is assessed to have an individual risk level of 4 based on the network isolation criteria 312, if the cloud service has network isolation features between levels 3 and 5. Note that the illustrated network isolation criteria are provided as non-limiting examples, and the network isolation criteria may differ in other examples.

Returning to FIG. 1, the risk assessment module 110 is configured to aggregate the individual risk scores 116 of the set of security criteria 114 for the cloud service 104A to generate an overall risk score 118 for the cloud service 104A. The overall risk score 118 indicates a level of risk that a customer would face by using the cloud service 104A. The risk assessment module 110 is configured to apply the risk assessment framework 112 to the cloud computing resource data of the other cloud services (e.g., the second cloud service 104B, the Nth cloud service 104C) to produce corresponding individual risk scores and overall risk scores for the other cloud services in the same manner described above.

Furthermore, the risk assessment module 110 is configured to repeatedly update the risk scores 116/118 of the plurality of cloud services as features and functions of the plurality of cloud services 104 change over time. In particular, the risk assessment module 110 is configured to receive updated cloud computing resource data 108 for the plurality cloud services 104. The risk assessment module 110 is configured to apply the risk assessment framework 112 to the updated cloud computing resource data 108 for the plurality of cloud services 104. The risk assessment framework 112 assigns updated individual risk scores 116 to each security criteria of the set of security criteria 114 based at least on evaluating the updated cloud computing resource data 108 to determine a degree to which the cloud services 104 comply with the corresponding security criteria. The risk assessment module 110 is configured to aggregate the updated individual risk scores 116 of the set of security criteria 114 for the cloud services 104 to generate an updated overall risk score 118 for the cloud services 104 that indicates a level of risk that a customer would face by using the cloud services 104.

The risk assessment module 110 may be configured to update the risk scores 116/116 of the plurality of cloud services 104 according to any suitable update schedule (e.g., periodically, based on receiving updated cloud computing resource data).

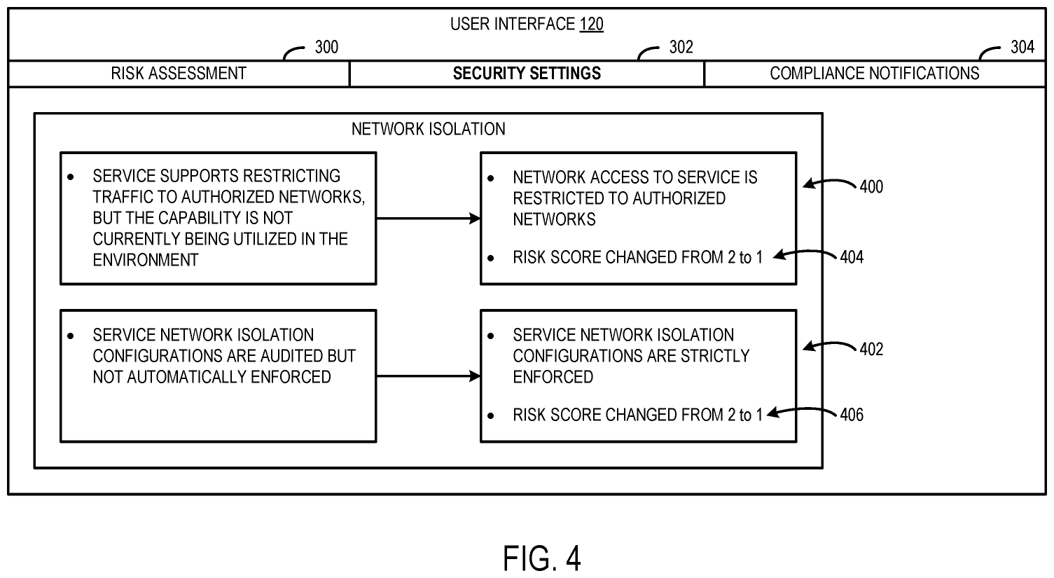

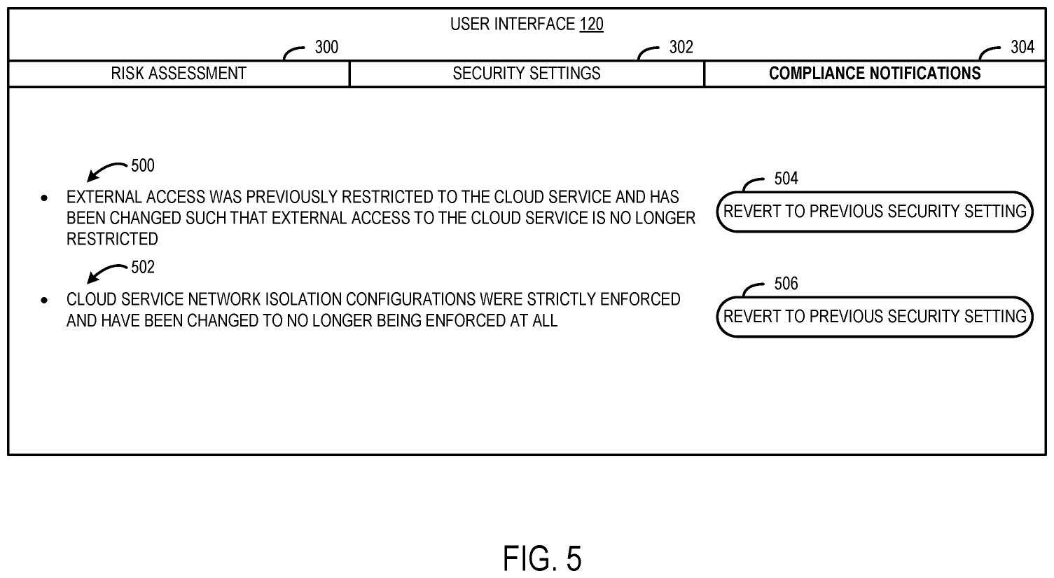

The computing system 102 is configured to generate a graphical user interface 120 that can be viewed by the customer computing system 106. The graphical user interface 120 functions as a dashboard for the customer computing system 106 to compare the risk levels of the plurality of different cloud services 104. FIGS. 3-5 show an example implementation of the graphical user interface 120. The graphical user interface 120 includes a risk assessment tab 300, a security settings tab 302, and a compliance notifications tab 304. The risk assessment tab 300 is displayed in FIG. 3. The security settings tab 302 is shown in FIG. 4. The compliance notifications tab 304 is shown in FIG. 5.

In FIG. 3, the risk assessment tab 300 of the graphical user interface 120 includes the set of security criteria 114 of the risk assessment framework 112. The set of security criteria 114 includes the subset of data plane criteria 308 and the subset of control plane criteria 310. The subset of data plane criteria 308 includes network isolation criteria 312, data protection criteria 314, monitoring criteria 316, access control criteria 318, and end users criteria 320. The subset of control plane criteria 310 includes telemetry criteria 322 and customer content criteria 324. The graphical user interface 120 includes, for each of the plurality of cloud services 104, individual risk scores 116 for each of the security criteria of the set of security criteria 114. The graphical user interface 120 includes, for each of the plurality of cloud services 104, a data plane subtotal risk score 326 that is an average of the individual risk scores for the subset of data plane criteria and a control plane subtotal risk score 328 that is an average of the individual risk scores for the subset of control plane criteria. The graphical user interface 120 includes, for each of the plurality of cloud services 104, the overall risk scores 118.

Returning to FIG. 1, the computing system 102 is configured to visually present, via a display (e.g., a display of the customer computing system 106), the graphical user interface 120 including the individual risk scores 116 of the plurality of cloud services 104 and the overall risk scores 118 of the plurality of cloud services 104. Further, updated individual risk scores 116 and updated overall risk scores 118 of the plurality of cloud services 104 are visually presented in the graphical user interface 120 when the updated risk scores are generated by the risk assessment module 110.

In some implementations, the risk scores 116/118 of the plurality of cloud services 104 are visually presented in the graphical user interface 120, and the computing system 102 is configured to receive user input, via the customer computing system 106, indicating a cloud service selected from the plurality of cloud services 104. For example, the customer can view the different risk scores of the different cloud services and choose which cloud service to use based on the customer's comfort level with the particular level of risk offered by the particular cloud service, among other factors. The computing system 102 is configured to assess and manage risk for the cloud service selected by the customer.

The computing system 102 includes a risk management module 122 that is configured to execute computer-automated risk management operations that automatically adjust security settings 124 of a cloud service, such as the cloud service 104A, based at least on cloud computing resource data of the cloud service 108A to enhance security of the cloud service 104A. Example computer-automated risk management operations include implementing encryption, enabling multi-factor authentication, applying patches and updates, managing access controls, and implementing secure backup and recovery procedures. The risk management module 122 can help customers identify, mitigate, and manage risks to sensitive data and operations in both the customer-facing data plane and the cloud control plane in an automated manner that does not require manual human intervention in order to optimize the security of the cloud service 104A to protect the highly secure workloads of the customer. While most conventional approaches focus on customer workloads in the data plane, the risk management module 122 is configured to manage risks in both planes to ensure customer workloads and data are protected not only from traditional threat vectors, such as other cloud tenants and external cyberthreats, but also from unauthorized access by CSP staff performing customer support activities.

In some implementations, the risk management module 122 may operate in a semi-automated fashion in which the risk management module 122 presents recommendations of adjustments that can be made to the security settings 124 to enhance the security of the cloud service. The customer can select which adjustments to make and the risk management module 122 executes risk management operations to adjust the security settings 124 that were selected by the customer.

In some implementations, the risk management module 122 is configured to perform risk management operations to reduce risk of a cloud service via training and processes. Risk management operations relating to training provide education and awareness to the customer and the service provider on the security best practices and policies for using the cloud service in a highly secure workload. Risk management operations relating to processes establish and enforce rules and procedures for using the cloud service in a highly secure workload, such as access control, data classification, backup and recovery, and incident management.

The computing system 102 is configured to visually present, via the display, the graphical user interface 120 including updated security settings 124 that are adjusted based at least on execution of the computer-automated risk management operation by the risk management module 122. In FIG. 4, the security settings tab 302 of the graphical user interface 120 is displayed. The security settings tab 302 includes updated security settings that are adjusted based at least on execution of the computer-automated risk management operations performed by the risk management module 122 (shown in FIG. 1). In the illustrated example, security settings related to the network isolation criteria 312 are updated to enhance security of the cloud service. At 400, a first security setting is updated based at least on execution of a first computer-automated risk management operation. In particular, the cloud service goes from not restricting network traffic to authorized networks to restricting network traffic and access to only authorized networks. At 402, a second security setting is updated based at least on execution of a second computer-automated risk management operation. In particular, network isolation configurations go from being audited but not automatically enforced to being strictly enforced.

In some implementations, the security settings tab 302 may indicate changes to the risk scores based on the security settings being updated. In the illustrated example, at 404, updating the first security setting results in the risk score going from 2 to 1. At 406, updating the second security setting results in the risk score also going from 2 to 1. In other words, by updating these security settings of the cloud service the risk level of using the cloud service is reduced and thus the risk scores of the cloud service are improved. The customer can view the security settings tab 302 of the graphical user interface 120 to determine the current security settings of the cloud service and what changes were made by the risk management module 122 to enhance the security of the cloud service and the corresponding changes to the risk scores resulting from the changes to the security settings.

The security settings tab 302 of the graphical user interface 120 may include any suitable security settings of the cloud service that are changed by the risk management module 122. In some implementations, the security settings tab 302 may distinguish between security settings that are updated by the risk management module 122 and other security settings that are manually changed by the customer.

The computing system 102 includes a compliance module 126 that is configured to monitor risks through automated compliance monitoring and enforcement. Compliance monitoring is the process of verifying that all implementations of the cloud service meet security standards 128 for highly secure workloads. The security standards 128 can be designated by the compliance module 126 and/or the customer computing system 106 in any suitable manner.

The computing system 102 is configured to receive security data 130 for the plurality of cloud services 104. In the illustrated example, the computing system 102 receive first security data 130A for the first cloud service 104A, second security data 130B for the second cloud service, and Nth security data 130C for the Nth cloud service 104C. The security data 130 may include logs, metrics, alerts, reports, and/or any other information related to activity and resources of the corresponding cloud service 104.

The compliance module 126 is configured to execute compliance monitoring operations that evaluate the security data 130 to verify that the cloud service 104 complies with the security standards 128. Such compliance monitoring can be performed continuously in an automated fashion repeatedly, on a periodic basis, on-demand, or according to another manner.

The compliance module 126 protects customer data and operations by automatically taking corrective actions when implementations of the cloud service deviate from the security standards 128 for using it in a highly secure workload. For example, the compliance module 126 may determine that the cloud service is out of compliance with security standards 128 based at least on the compliance monitoring operation indicating such. Based on this determination, the compliance module 126 may execute a computer-automated corrective operation that helps the cloud service return to compliance with the security standards 128.

In some examples, the computer-automated corrective operation may include visually presenting, via the display, a notification 132 indicating that the cloud service is out of compliance with the security standards 128. For example, the notification 132 can be visually presented in the graphical user interface 120. In FIG. 5, the compliance notification tab 304 of the graphical user interface 120 is displayed.

The compliance notification tab 304 includes notifications of various security settings that have been changed that cause the cloud service to be out of compliance. A first notification 500 specifies that external access was previously restricted to cloud service and has been changed such that external access to the cloud service is no longer restricted. A second notification 502 specifies that cloud service network isolation configurations were strictly enforced and have been changed to no longer being enforced at all. For example, the notifications 500 and 502 may correspond to the notifications 132 shown in FIG. 1. In each case, the notifications 500 and 502 describe changes to security settings that caused the cloud service to be out of compliance with the security standards 128. The compliance notification tab 304 includes user interface buttons 504 and 506 that are selectable via user input to revert the changes to the security settings in order to help the cloud service return to compliance with the security standards 128. In some implementations, the compliance notification tab 304 optionally may include updated risk scores that change based on changes to the security settings.

Returning to FIG. 1, in some other examples, the compliance module 126 mat execute the computer-automated corrective operation by automatically adjusting security settings of the cloud service to return the cloud service to compliance with the security standards. For example, this operation can be performed without human intervention in order to automatically keep the cloud service in compliance with the security standards 128. The compliance module 126 leverages the capabilities of the cloud services 104 to collect and analyze the security data 130 from the cloud services 104, and to execute predefined responses when the cloud services deviate from the security standards 128. The automated compliance monitoring and enforcement reduces the human error and intervention that may compromise the security of the cloud services.

The features provided by the risk assessment module 110, the risk management module 122, and the compliance module 126 may be continually applied throughout the life cycle of each highly secure workload through final termination. Outputs from continuous monitoring of the cloud computing resource data 108 and the security data 130 are provided as input to recurring quantitative risk assessments, which are in turn used to implement additional technical measures, training, and process to mitigate any newly identified risk areas and provides enduring protection of customer data and operations, even as customer architectures and cloud services rapidly evolve.

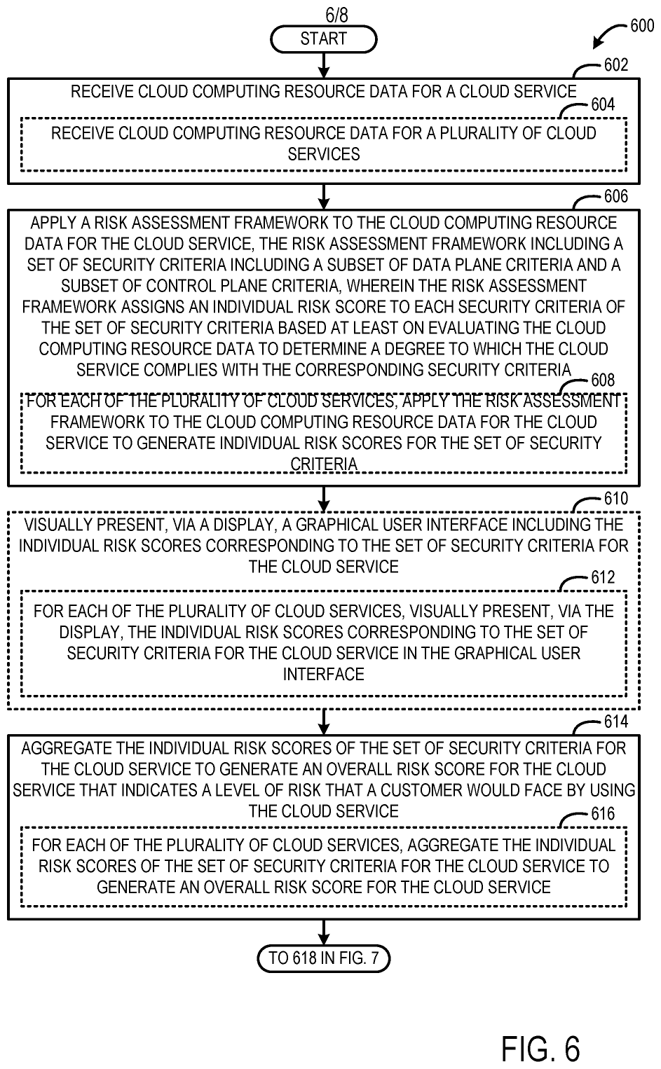

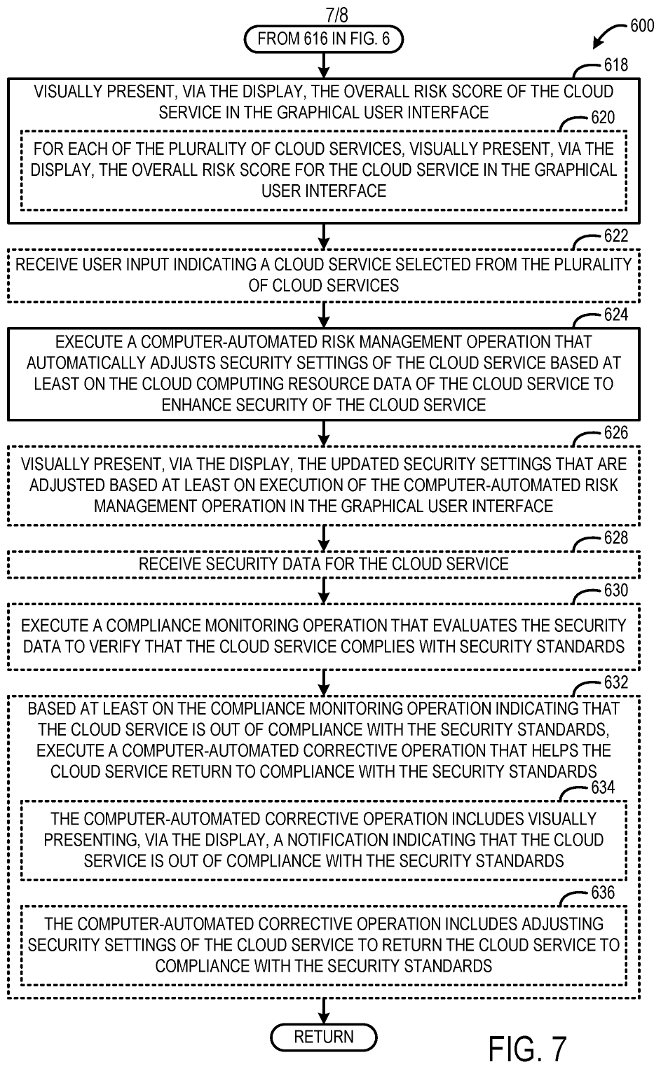

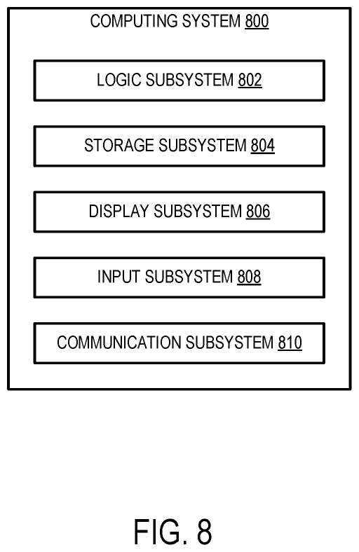

FIGS. 6-7 shows an example computer-implemented method 600 for assessing and managing risk of a cloud service provider. For example, the computer-implemented method may be performed by the computing system 102 shown in FIG. 1 or the computing system 800 shown in FIG. 8. At 602, the computer-implemented method 600 includes receiving cloud computing resource data for a cloud service. In some implementations where a plurality of cloud services are being assessed for risk, at 604, the computer-implemented method 600 may include receiving cloud computing resource data for a plurality of cloud services.

At 606, the computer-implemented method 600 includes applying a risk assessment framework to the cloud computing resource data for the cloud service. The risk assessment framework includes a set of security criteria including a subset of data plane criteria and a subset of control plane criteria. The risk assessment framework assigns an individual risk score to each security criteria of the set of security criteria based at least on evaluating the cloud computing resource data to determine a degree to which the cloud service complies with the corresponding security criteria. In some implementations, at 608, the computer-implemented method 600 may include for each of the plurality of cloud services, applying the risk assessment framework to the could computing resource data for the cloud service to generate individual risk scores for the set of security criteria.

In some implementations, at 610, the computer-implemented method 600 may include visually presenting, via a display, a graphical user interface including the individual risk scores corresponding to the set of security criteria for the cloud service. In some implementations where a plurality of cloud services are being assessed for risk, at 612, the computer-implemented method 600 may include for each of the plurality of cloud services, visually presenting, via the display, the individual risk scores corresponding to the set of security criteria for the cloud service in the graphical user interface.

At 614, the computer-implemented method 600 includes aggregating the individual risk scores of the set of security criteria for the cloud service to generate an overall risk score for the cloud service that indicates a level of risk that a customer would face by using the cloud service. In some implementations where a plurality of cloud services are being assessed for risk, at 616, the computer-implemented method 600 may include for each of the plurality of cloud services, aggregating the individual risk scores of the set of security criteria for the cloud service to generate an overall risk score for the cloud service.

In FIG. 7, at 618, the computer-implemented method 600 includes visually presenting, via the display, the overall risk score of the cloud service in the graphical user interface. In some implementations where a plurality of cloud services are being assessed for risk, at 620, the computer-implemented method 600 may include for each of the plurality of cloud services, visually presenting, via the display, the overall risk score of the cloud service in the graphical user interface.

In some implementations where a plurality of cloud services are being assessed for risk, at 622, the computer-implemented method 600 may include receiving user input indicating a cloud service selected from the plurality of cloud services.

At 624 the computer-implemented method 600 includes executing a computer-automated risk management operation that automatically adjusts security settings of the cloud service based at least on cloud computing resource data of the cloud service to enhance security of the cloud service. In some implementations where a plurality of cloud services are being assessed for risk this step is performed for the selected cloud service.

In some implementations, at 626, the computer-implemented method 600 may include visually presenting, via the display, updated security settings that are adjusted based at least on execution of the computer-automated risk management operation in the graphical user interface.

In some implementations, at 628, the computer-implemented method 600 may include receiving security data for the cloud service. In some implementations where a plurality of cloud services are being assessed for risk this step is performed for the selected cloud service.

In some implementations, at 630, the computer-implemented method 600 may include executing a compliance monitoring operation that evaluates the security data to verify that the cloud service complies with security standards.

In some implementations, at 632, the computer-implemented method 600 may include, based at least on the compliance monitoring operation indicating that the cloud service is out of compliance with the security standards, executing a computer-automated corrective operation that helps the cloud service return to compliance with the security standards. In some implementations, at 634, the computer-automated corrective operation includes visually presenting, via the display, a notification indicating that the cloud service is out of compliance with the security standards. In some implementations, at 636, the computer-automated corrective operation includes adjusting security settings of the cloud service to return the cloud service to compliance with the security standards.

The computer-implemented method may be performed repeatedly to re-assess risk for one or more cloud services as well as to provide automatic risk management and compliance functionality for a cloud service continually over the course of a lifespan of a secure workload.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 8 schematically shows a simplified representation of a computing system 800 configured to provide any to all of the compute functionality described herein. For example, the computing system 800 may correspond to the computing system 102, the plurality of cloud services 104, and the customer computing system 106 shown in FIG. 1. Computing system 800 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 800 includes a logic subsystem 802 and a storage subsystem 804. Computing system 800 may optionally include a display subsystem 806, input subsystem 808, communication subsystem 810, and/or other subsystems not shown in FIG. 8.

Logic subsystem 802 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 804 includes one or more physical devices configured to temporarily and/or permanently hold computer information such as data and instructions executable by the logic subsystem. When the storage subsystem includes two or more devices, the devices may be collocated and/or remotely located. Storage subsystem 804 may include volatile, nonvolatile, dynamic, static, read/write, read-only, random-access, sequential-access, location-addressable, file-addressable, and/or content-addressable devices. Storage subsystem 804 may include removable and/or built-in devices. When the logic subsystem executes instructions, the state of storage subsystem 804 may be transformed—e.g., to hold different data.

Aspects of logic subsystem 802 and storage subsystem 804 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

The term “module” may be used to describe an aspect of computing system 800 implemented to perform a particular function. In some cases, a module may be instantiated via logic machine 802 executing instructions held by storage subsystem 804. It will be understood that different modules may be instantiated from the same application, service, code block, object, library, routine, API, function, etc. Likewise, the same module may be instantiated by different applications, services, code blocks, objects, routines, APIs, functions, etc. The term “module” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 may be used to present a visual representation of data held by storage subsystem 804. This visual representation may take the form of a graphical user interface (GUI). Display subsystem 806 may include one or more display devices utilizing virtually any type of technology. In some implementations, display subsystem may include one or more virtual-, augmented-, or mixed reality displays.

When included, input subsystem 808 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 810 may be configured to communicatively couple computing system 800 with one or more other computing devices. Communication subsystem 810 may include wired and/or wireless communication devices compatible with one or more different communication protocols. The communication subsystem may be configured for communication via personal-, local- and/or wide-area networks.

In an example, a computing system comprises a logic subsystem, and a storage subsystem holding instructions executable by the logic subsystem to receive cloud computing resource data for a cloud service, apply a risk assessment framework to the cloud computing resource data for the cloud service, the risk assessment framework including a set of security criteria including a subset of data plane criteria and a subset of control plane criteria, wherein the risk assessment framework assigns an individual risk score to each security criteria of the set of security criteria based at least on evaluating the cloud computing resource data to determine a degree to which the cloud service complies with the corresponding security criteria, aggregate the individual risk scores of the set of security criteria for the cloud service to generate an overall risk score for the cloud service that indicates a level of risk that a customer would face by using the cloud service, visually present, via a display, a graphical user interface including the overall risk score of the cloud service, and execute a computer-automated risk management operation that automatically adjusts security settings of the cloud service based at least on the cloud computing resource data for the cloud service to enhance security of the cloud service. In this example and/or other examples, the storage subsystem may hold instructions executable by the logic subsystem to visually present, via the display, updated security settings that are adjusted based at least on execution of the computer-automated risk management operation in the graphical user interface. In this example and/or other examples, the storage subsystem may hold instructions executable by the logic subsystem to receive updated cloud computing resource data for the cloud service, apply the risk assessment framework to the updated cloud computing resource data for the cloud service, wherein the risk assessment framework assigns an updated individual risk to each security criteria of the set of security criteria based at least on evaluating the updated cloud computing resource data to determine a degree to which the cloud service complies with the corresponding security criteria, and aggregate the updated individual risk scores of the set of security criteria for the cloud service to generate an updated overall risk score for the cloud service that indicates a level of risk that a customer would face by using the cloud service. In this example and/or other examples, the storage subsystem may hold instructions executable by the logic subsystem to receive security data for the cloud service, execute a compliance monitoring operation that evaluates the security data to verify that the cloud service complies with security standards, and based at least on the compliance monitoring operation indicating that the cloud service is out of compliance with the security standards, execute a computer-automated corrective operation that helps the cloud service return to compliance with the security standards. In this example and/or other examples, the computer-automated corrective operation may include visually presenting, via the display, a notification indicating that the cloud service is out of compliance with the security standards in the graphical user interface. In this example and/or other examples, the computer-automated corrective operation may include adjusting security settings of the cloud service to return the cloud service to compliance with the security standards. In this example and/or other examples, the graphical user interface may include overall risk scores for a plurality of different cloud services, and the storage subsystem may hold instructions executable by the logic subsystem to receive user input indicating a cloud service selected from the plurality of cloud services, and the computer-automated risk management operation may be executed to automatically adjust security settings of the selected cloud service based at least on cloud computing resource data for the selected cloud service. In this example and/or other examples, the subset of data plane criteria mya include network isolation, data protection, monitoring, access control, and end users criteria, and the subset of control plane criteria may include telemetry and customer content criteria. In this example and/or other examples, the computer-automated risk management operation may be executed to automatically adjust security settings of the cloud service based at least on the cloud computing resource data for the cloud service by one or more of implementing encryption, enabling multi-factor authentication, applying patches and updates, managing access controls, and implementing secure backup and recovery procedures.

In another example, a computer-implemented method comprises receiving cloud computing resource data for a cloud service, applying a risk assessment framework to the cloud computing resource data for the cloud service, the risk assessment framework including a set of security criteria including a subset of data plane criteria and a subset of control plane criteria, the risk assessment framework assigns an individual risk score to each security criteria of the set of security criteria based at least on evaluating the cloud computing resource data to determine a degree to which the cloud service complies with the corresponding security criteria, aggregating the individual risk scores of the set of security criteria for the cloud service to generate an overall risk score for the cloud service that indicates a level of risk that a customer would face by using the cloud service, visually presenting, via a display, a graphical user interface including the overall risk score of the cloud service, and executing a computer-automated risk management operation that automatically adjusts security settings of the cloud service based at least on the cloud computing resource data for the cloud service to enhance security of the cloud service. In this example and/or other examples, the computer-implemented method may further comprise visually presenting, via the display, updated security settings that are adjusted based at least on execution of the computer-automated risk management operation in the graphical user interface. In this example and/or other examples, the computer-implemented method may further comprise receiving updated cloud computing resource data for the cloud service, applying the risk assessment framework to the updated cloud computing resource data for the cloud service, the risk assessment framework may assign an updated individual risk to each security criteria of the set of security criteria based at least on evaluating the updated cloud computing resource data to determine a degree to which the cloud service complies with the corresponding security criteria, aggregating the updated individual risk scores of the set of security criteria for the cloud service to generate an updated overall risk score for the cloud service that indicates a level of risk that a customer would face by using the cloud service. In this example and/or other examples, the computer-implemented method may further comprise receiving security data for the cloud service, executing a compliance monitoring operation that evaluates the security data to verify that the cloud service complies with security standards, and based at least on the compliance monitoring operation indicating that the cloud service is out of compliance with the security standards, executing a computer-automated corrective operation that helps the cloud service return to compliance with the security standards. In this example and/or other examples, the computer-automated corrective operation may include visually presenting, via the display, a notification indicating that the cloud service is out of compliance with the security standards in the graphical user interface. In this example and/or other examples, the computer-automated corrective operation may include adjusting security settings of the cloud service to return the cloud service to compliance with the security standards. In this example and/or other examples, the graphical user interface may include overall risk scores for a plurality of different cloud services, and the computer-implemented method may further comprise receiving user input indicating a cloud service selected from the plurality of cloud services, and the computer-automated risk management operation mya be executed to automatically adjust security settings of the selected cloud service based at least on the cloud computing resource data for the selected cloud service. In this example and/or other examples, the subset of data plane criteria may include network isolation, data protection, monitoring, access control, and end users criteria, and the subset of control plane criteria may include telemetry and customer content criteria. In this example and/or other examples, the computer-automated risk management operation may be executed to automatically adjust security settings of the cloud service based at least on the cloud computing resource data for the cloud service by one or more of implementing encryption, enabling multi-factor authentication, applying patches and updates, managing access controls, and implementing secure backup and recovery procedures.

In another example, a computing system comprises a logic subsystem, and a storage subsystem holding instructions executable by the logic subsystem to for each of a plurality of cloud services, receive cloud computing resource data for the cloud service, for each of the plurality of cloud services, apply a risk assessment framework to the cloud computing resource data for the cloud service, the risk assessment framework including a set of security criteria including a subset of data plane criteria and a subset of control plane criteria, wherein the risk assessment framework assigns an individual risk score to each security criteria of the set of security criteria based at least on evaluating the cloud computing resource data to determine a degree to which the cloud service complies with the corresponding security criteria, for each of the plurality of cloud services, aggregate the individual risk scores of the set of security criteria for the cloud service to generate an overall risk score for the cloud service that indicates a level of risk that a customer would face by using the cloud service, visually present, via a display, a graphical user interface including the overall risk scores of the plurality of cloud services, receive user input indicating a cloud service selected from the plurality of cloud services, and execute a computer-automated risk management operation that automatically adjusts security settings of the selected cloud services based at least on the cloud computing resource data for the cloud service to enhance security of the selected cloud services. In this example and/or other examples, the storage subsystem may hold instructions executable by the logic subsystem to receive security data for the selected cloud service, execute a compliance monitoring operation that evaluates the security data to verify that the selected cloud service complies with security standards, and based at least on the compliance monitoring operation indicating that the selected cloud service is out of compliance with the security standards, execute a computer-automated corrective operation that helps the selected cloud service return to compliance with the security standards.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a logic subsystem; and
a storage subsystem holding instructions executable by the logic subsystem to:
receive cloud computing resource data for a cloud service;
apply a risk assessment framework to the cloud computing resource data for the cloud service, the risk assessment framework including a set of security criteria including a subset of data plane criteria and a subset of control plane criteria, wherein the risk assessment framework assigns an individual risk score to each security criteria of the set of security criteria based at least on evaluating the cloud computing resource data to determine a degree to which the cloud service complies with the corresponding security criteria;
aggregate the individual risk scores of the set of security criteria for the cloud service to generate an overall risk score for the cloud service that indicates a level of risk that a customer would face by using the cloud service;
visually present, via a display, a graphical user interface including the overall risk score of the cloud service; and
execute a computer-automated risk management operation that automatically adjusts security settings of the cloud service based at least on the cloud computing resource data for the cloud service to enhance security of the cloud service.

2. The computing system of claim 1, wherein the storage subsystem holds instructions executable by the logic subsystem to:
visually present, via the display, updated security settings that are adjusted based at least on execution of the computer-automated risk management operation in the graphical user interface.

3. The computing system of claim 1, wherein the storage subsystem holds instructions executable by the logic subsystem to:
receive updated cloud computing resource data for the cloud service;
apply the risk assessment framework to the updated cloud computing resource data for the cloud service, wherein the risk assessment framework assigns an updated individual risk to each security criteria of the set of security criteria based at least on evaluating the updated cloud computing resource data to determine a degree to which the cloud service complies with the corresponding security criteria; and
aggregate the updated individual risk scores of the set of security criteria for the cloud service to generate an updated overall risk score for the cloud service that indicates a level of risk that a customer would face by using the cloud service.

4. The computing system of claim 1, wherein the storage subsystem holds instructions executable by the logic subsystem to:
receive security data for the cloud service;
execute a compliance monitoring operation that evaluates the security data to verify that the cloud service complies with security standards; and
based at least on the compliance monitoring operation indicating that the cloud service is out of compliance with the security standards, execute a computer-automated corrective operation that helps the cloud service return to compliance with the security standards.

5. The computing system of claim 4, wherein the computer-automated corrective operation includes visually presenting, via the display, a notification indicating that the cloud service is out of compliance with the security standards in the graphical user interface.

6. The computing system of claim 4, wherein the computer-automated corrective operation includes adjusting security settings of the cloud service to return the cloud service to compliance with the security standards.

7. The computing system of claim 1, wherein the graphical user interface includes overall risk scores for a plurality of different cloud services, and wherein the storage subsystem holds instructions executable by the logic subsystem to:
receive user input indicating a cloud service selected from the plurality of cloud services, and wherein the computer-automated risk management operation is executed to automatically adjust security settings of the selected cloud service based at least on cloud computing resource data for the selected cloud service.

8. The computing system of claim 1, wherein the subset of data plane criteria includes network isolation, data protection, monitoring, access control, and end users criteria, and wherein the subset of control plane criteria includes telemetry and customer content criteria.

9. The computing system of claim 1, wherein the computer-automated risk management operation is executed to automatically adjust security settings of the cloud service based at least on the cloud computing resource data for the cloud service by one or more of implementing encryption, enabling multi-factor authentication, applying patches and updates, managing access controls, and implementing secure backup and recovery procedures.

10. A computer-implemented method comprising:
receiving cloud computing resource data for a cloud service;
applying a risk assessment framework to the cloud computing resource data for the cloud service, the risk assessment framework including a set of security criteria including a subset of data plane criteria and a subset of control plane criteria, wherein the risk assessment framework assigns an individual risk score to each security criteria of the set of security criteria based at least on evaluating the cloud computing resource data to determine a degree to which the cloud service complies with the corresponding security criteria;
aggregating the individual risk scores of the set of security criteria for the cloud service to generate an overall risk score for the cloud service that indicates a level of risk that a customer would face by using the cloud service;
visually presenting, via a display, a graphical user interface including the overall risk score of the cloud service; and
executing a computer-automated risk management operation that automatically adjusts security settings of the cloud service based at least on the cloud computing resource data for the cloud service to enhance security of the cloud service.

11. The computer-implemented method of claim 10, further comprising:
visually presenting, via the display, updated security settings that are adjusted based at least on execution of the computer-automated risk management operation in the graphical user interface.

12. The computer-implemented method of claim 10, further comprising:
receiving updated cloud computing resource data for the cloud service;
applying the risk assessment framework to the updated cloud computing resource data for the cloud service, wherein the risk assessment framework assigns an updated individual risk to each security criteria of the set of security criteria based at least on evaluating the updated cloud computing resource data to determine a degree to which the cloud service complies with the corresponding security criteria; and
aggregating the updated individual risk scores of the set of security criteria for the cloud service to generate an updated overall risk score for the cloud service that indicates a level of risk that a customer would face by using the cloud service.

13. The computer-implemented method of claim 10, further comprising:
receiving security data for the cloud service;
executing a compliance monitoring operation that evaluates the security data to verify that the cloud service complies with security standards; and
based at least on the compliance monitoring operation indicating that the cloud service is out of compliance with the security standards, executing a computer-automated corrective operation that helps the cloud service return to compliance with the security standards.

14. The computer-implemented method of claim 13, wherein the computer-automated corrective operation includes visually presenting, via the display, a notification indicating that the cloud service is out of compliance with the security standards in the graphical user interface.

15. The computer-implemented method of claim 13, wherein the computer-automated corrective operation includes adjusting security settings of the cloud service to return the cloud service to compliance with the security standards.

16. The computer-implemented method of claim 10, wherein the graphical user interface includes overall risk scores for a plurality of different cloud services, and wherein the computer-implemented method further comprises receiving user input indicating a cloud service selected from the plurality of cloud services, and wherein the computer-automated risk management operation is executed to automatically adjust security settings of the selected cloud service based at least on the cloud computing resource data for the selected cloud service.

17. The computer-implemented method of claim 10, wherein the subset of data plane criteria includes network isolation, data protection, monitoring, access control, and end users criteria, and wherein the subset of control plane criteria includes telemetry and customer content criteria.

18. The computer-implemented method of claim 10, wherein the computer-automated risk management operation is executed to automatically adjust security settings of the cloud service based at least on the cloud computing resource data for the cloud service by one or more of implementing encryption, enabling multi-factor authentication, applying patches and updates, managing access controls, and implementing secure backup and recovery procedures.

19. A computing system comprising:
a logic subsystem; and
a storage subsystem holding instructions executable by the logic subsystem to:
for each of a plurality of cloud services, receive cloud computing resource data for the cloud service;
for each of the plurality of cloud services, apply a risk assessment framework to the cloud computing resource data for the cloud service, the risk assessment framework including a set of security criteria including a subset of data plane criteria and a subset of control plane criteria, wherein the risk assessment framework assigns an individual risk score to each security criteria of the set of security criteria based at least on evaluating the cloud computing resource data to determine a degree to which the cloud service complies with the corresponding security criteria;
for each of the plurality of cloud services, aggregate the individual risk scores of the set of security criteria for the cloud service to generate an overall risk score for the cloud service that indicates a level of risk that a customer would face by using the cloud service;
visually present, via a display, a graphical user interface including the overall risk scores of the plurality of cloud services;
receive user input indicating a cloud service selected from the plurality of cloud services; and
execute a computer-automated risk management operation that automatically adjusts security settings of the selected cloud services based at least on the cloud computing resource data for the cloud service to enhance security of the selected cloud services.

20. The computing system of claim 19, wherein the storage subsystem holds instructions executable by the logic subsystem to:
receive security data for the selected cloud service;
execute a compliance monitoring operation that evaluates the security data to verify that the selected cloud service complies with security standards; and
based at least on the compliance monitoring operation indicating that the selected cloud service is out of compliance with the security standards, execute a computer-automated corrective operation that helps the selected cloud service return to compliance with the security standards.
